(19) United States
(12) Patent Application Publication
(10) Pub. No.: US 2024/0367724 A1
(43) Pub. Date: Nov. 7, 2024

(54) MOUNTING ARRANGEMENT FOR MOUNTING A CAB TO A CHASSIS OF A VEHICLE

(71) Applicant: Volvo Truck Corporation, Göteborg (SE)

(72) Inventors: Lalit SAROHA, Oak Ridge, NC (US); Francis RIFFARD, St Bonnet De Mure (FR); Julien GIBOUDEAU, Sathonay Village (FR)

(21) Appl. No.: 18/623,218

(22) Filed: Apr. 1, 2024

(30) Foreign Application Priority Data
May 4, 2023 (EP) 23171611.9

(51) Int. Cl. B62D 24/02

(52) U.S. Cl. CPC B62D 24/02

(57) ABSTRACT

A mounting arrangement for mounting a cab to a chassis of a vehicle, the mounting arrangement comprising a chassis bracket adapted to be mounted to the chassis, a cab bracket adapted to be mounted to the cab, and a mounting unit adapted to connect the chassis bracket and the cab bracket, wherein the mounting unit comprises a core member, the core member comprising an aperture being arranged to extend along a mounting axis extending at least partially in a vertical direction, whereby the mounting arrangement further comprises a fastening member adapted to be mounted to the mounting unit and one of the cab bracket and the chassis bracket, the fastening member being arranged to extend along the mounting axis inside the aperture.

### PRIORITY APPLICATIONS

The present application claims priority to European Patent Application No. 23171611.9, filed on May 4, 2023, and entitled “MOUNTING ARRANGEMENT FOR MOUNTING A CAB TO A CHASSIS OF A VEHICLE,” which is incorporated herein by reference in its entirety.

### TECHNICAL FIELD

The disclosure relates generally to a mounting arrangement. In particular aspects, the disclosure relates to a mounting arrangement for mounting a cab to a chassis of a vehicle. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

In the field of vehicles, the cab is typically mounted to a chassis frame by means of a mounting arrangement. To provide softer travel and more comfort to the driver and passengers of the vehicle, such a mounting arrangement may often include an elastic bushing interface for preventing vibrations from the chassis propagating to the cab.

Such mounting arrangements typically forms a horizontal connection between the cab and the chassis frame. This poses a challenge in terms of wear of the bushing of the mounting arrangement. Furthermore, aligning the cab, chassis and mounting arrangement is a complex and time consuming process.

### SUMMARY

According to a first aspect of the disclosure, a mounting arrangement for mounting a cab to a chassis of a vehicle is provided. The mounting arrangement comprises a chassis bracket adapted to be mounted to the chassis, a cab bracket adapted to be mounted to the cab, and a mounting unit adapted to connect the chassis bracket and the cab bracket.

The mounting unit comprises a core member. The core member comprises an aperture. The aperture is arranged to extend along a mounting axis. The mounting axis extends at least partially in a vertical direction. The mounting arrangement further comprises a fastening member. The fastening member is adapted to be mounted to the mounting unit and one of the cab bracket and the chassis bracket. The fastening member is arranged to extend along the mounting axis inside the aperture. The first aspect of the disclosure may seek to provide a less complex and more efficient mounting and aligning of a cab to a chassis of a vehicle. A technical benefit may include that the cab is easily aligned and mounted to the chassis due to fastening member and mounting unit providing a guide since the cab and mounting unit may rest on the chassis during mounting and alignment. Another technical benefit is that the vertical interface between the chassis and cab enables space for damping elements for example for mitigating vertical rebound travel.

Optionally in some examples, including in at least one preferred example, the fastening member may comprise a first end portion adapted to be mounted to the cab bracket or the chassis bracket. The fastening member may comprise a second end portion opposite to said first end portion and adapted to be arranged inside the aperture.

Optionally in some examples, including in at least one preferred example, the fastening member may be adapted to be mounted to the chassis bracket. A technical benefit may include that the fastening member enables mounting of the mounting unit from below, whereby the cab may rest on the mounting unit during mounting making aligning of the chassis and cab more efficient.

Optionally in some examples, including in at least one preferred example, the chassis bracket may comprise a mounting flange. The mounting flange may be adapted to support the mounting unit such that the mounting unit is supported by the mounting flange. A technical benefit may include that the cab may rest securely on top of the chassis bracket during aligning and mounting.

Optionally in some examples, including in at least one preferred example, the mounting unit may comprise a bushing. The core member may be mounted to the bushing. A technical benefit may include that the bushing may enable relative movement between the parts of the mounting arrangement, thereby enabling additional damping.

Optionally in some examples, including in at least one preferred example, the bushing may be in a flexible material such as an elastomeric material. A technical benefit may include that the bushing provides further damping between the cab and the chassis.

Optionally in some examples, including in at least one preferred example, the core member may be resiliently arranged in the bushing. A technical benefit may include that the core member is movable in response to loads and vibrations, whereby the damping provided by the mounting arrangement may be improved.

Optionally in some examples, including in at least one preferred example, the core member and the bushing may be coaxially arranged along the mounting axis. A technical benefit may include that the mounting arrangement is more compact and space-efficient.

Optionally in some examples, including in at least one preferred example, the mounting unit may further comprise a housing, whereby the bushing may be mounted to the housing and the bushing may be arranged between the housing and the core member. A technical benefit may include that the bushing may provide relative movement between the core member and the fastening member relative to the housing enabling further damping.

Optionally in some examples, including in at least one preferred example, the fastening member may be adapted to be mounted to the mounting unit and to one of the cab bracket and the chassis bracket and wherein housing may be adapted to be mounted to the other of said cab bracket and chassis bracket.

Optionally in some examples, including in at least one preferred example, the mounting arrangement may further comprise a cab damping member arranged at an end of the mounting unit facing the cab bracket, whereby the cab damping member may be arranged between the core member and the cab bracket. A technical benefit may include that the cab damping member may reduce and control rebound travel of the cab.

Optionally in some examples, including in at least one preferred example, the mounting arrangement may further comprise a chassis damping member arranged at an end of the mounting unit facing the chassis bracket, whereby the chassis damping member may be arranged between the core member and the chassis bracket. A technical benefit may include that the chassis damping member may reduce and control compression travel of the cab.

Optionally in some examples, including in at least one preferred example, the chassis damping member and/or the cab damping member may be formed as an integrated part of the bushing. A technical benefit may include that a more space and cost efficient mounting arrangement is achieved.

Optionally in some examples, including in at least one preferred example, the chassis damping member and/or the cab damping member may be formed as a separate element.

Optionally in some example, including in at least one preferred example, the cab bracket may comprise a guiding portion adapted to provide a guide for movement of the mounting unit in a direction extending substantially orthogonally to the mounting axis. A technical benefit may include that the mounting unit may be guided into position relative the chassis bracket during mounting and aligning.

Optionally in some examples, including in at least one preferred example, the mounting arrangement may further comprise a mounting unit fastening element adapted to be mounted to the mounting unit, whereby the mounting unit fastening element may be provided with a washer element and the cab damping member may be clamped between the washer element and the housing. A technical benefit may include that a secure and durable mounting of the cab damping member is achieved.

Optionally in some examples, including in at least one preferred example, the aperture may comprise a first aperture section and a second aperture section, wherein the second aperture section may be axially displaced relative the first aperture section along the mounting axis and wherein the first aperture section may be adapted to receive the fastening member and the second aperture section may be adapted to receive the mounting unit fastening element.

Optionally in some examples, including in at least one preferred example, the first aperture section may have a larger diameter than the second aperture section. A technical benefit may include that the fastening member is secured in the core member in a more durable and robust manner.

Optionally in some examples, including in at least one preferred example, the chassis bracket may be adapted to extend from the chassis in a direction extending at least partially along the mounting axis and/or the cab bracket may be adapted to extend from the cab in a direction extending at least partially along the mounting axis. A technical benefit may include that the brackets are more easily alignable and the chassis bracket potentially providing a positive stop for the cab bracket or cab during mounting and aligning.

According to a second aspect of the disclosure, a vehicle is provided. The vehicle may comprise a cab, a chassis and a mounting arrangement. The mounting arrangement may be a mounting arrangement according to any of the aforementioned examples. The second aspect of the disclosure may seek to provide a vehicle with a less complex and more efficient mounting of a cab to a chassis of a vehicle. A technical benefit may include that the cab is easily aligned and mounted to the chassis due to fastening member and mounting unit providing a guide since the cab and mounting unit may rest on the chassis during mounting and alignment. Another technical benefit is that the vertical interface between the chassis and cab enables space for damping elements for example for mitigating vertical rebound travel.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary mounting arrangement according to an example.

FIG. 2 is an exemplary mounting arrangement according to an example.

FIG. 3 is another view of FIG. 2 according to one example.

FIG. 4 is another view of FIG. 2 according to one example.

FIG. 5 depicts a portion of a mounting arrangement according to one example.

FIG. 6 is a perspective view of parts of the mounting arrangement of FIG. 5.

FIG. 7 is a top view of parts of the mounting arrangement of FIG. 5.

### DETAILED DESCRIPTION

The detailed description set forth below provides information and examples of the disclosed technology with sufficient detail to enable those skilled in the art to practice the disclosure.

Mounting arrangements for mounting of a cab to a chassis of a vehicle are sometimes adapted to also minimize vibrations in the cabin and may be referred to as cab mount isolators. A cab mount isolator is a type of vibration isolation system used in automobiles, trucks, and other heavy vehicles to reduce the transmission of vibrations from the chassis to the cabin. The purpose of a cab mount isolator is to provide a comfortable and safe ride for the vehicle occupants by reducing the transfer of noise, vibrations, and harshness from the vehicle's engine, transmission, and suspension to the cabin.

The cab mount isolator functions by providing a flexible link between the vehicle's chassis and the cab. It may include a rubber or elastomeric component that is compressed between the chassis and the cab. The isolator is designed to absorb the vibrations and shocks generated by the vehicle's movement and prevent them from reaching the cab.

Cab mount isolators are typically installed at strategic locations around the vehicle's chassis, including the front and rear mounts, the transmission mount, and the cross members. The isolators can be designed to accommodate different types of loads and operating conditions, such as vertical, lateral, and longitudinal forces, and temperature variations.

In summary, the cab mount isolator plays a crucial role in providing a smooth and comfortable ride for the vehicle occupants, while also reducing the wear and tear on the vehicle's components.

Conventional interfaces for mounting of a cab to a chassis of the vehicle typically extend horizontally, whereby the installation of the cab to the chassis mainly takes place in a horizontal direction. Depending on the horizontal direction chosen for the interface, various challenges may occur.

In the case of a horizontal interface extending along the width of the vehicle (corresponding to a Y-direction of a global vehicle coordinate system), challenges may include a limited lifetime due to the elastic elements for damping separating from the rigid load bearing elements of the interface under repetitive cab yaw movement. This may in turn cause issues with the durability of the cab.

In the case of a horizontal interface extending along the length of the vehicle (corresponding to a X-direction of a global vehicle coordinate system), challenges may include difficulties with decking the cab to the chassis as well as issues with the driver comfort. Particularly in the field of heavy vehicles, such horizontal interfaces propagate forces and vibrations from the trailer to the cab, negatively impacting the driver comfort.

There is thus a challenge in the design of a mounting arrangement to balance the ability for the mounting arrangement to handle loads and vibrations and thereby function as an efficient cab mount isolator and the ability to enable easier and more durable mounting of the cab to the chassis.

The examples of the disclosure herein may serve to address the above issues and/or may bring other potential improvements or advantages relative to conventional mounting arrangements.

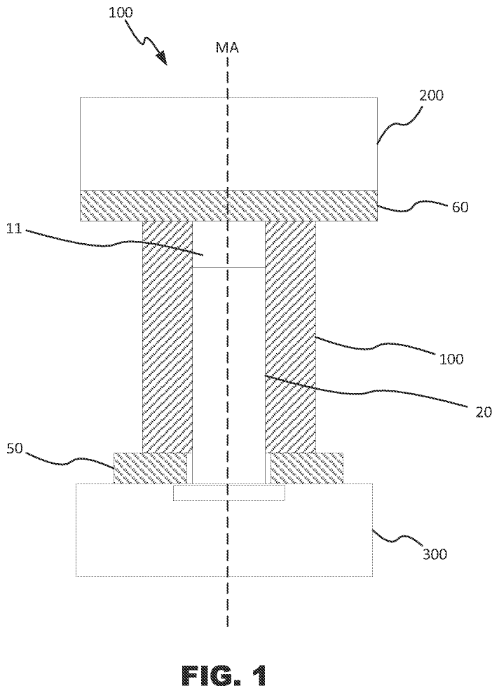

FIG. 1 is an exemplary mounting arrangement 100 for mounting a cab 200 to a chassis 300 of a vehicle according to an example. FIG. 1 schematically shows a partial cross-section of the mounting arrangement 100.

The mounting arrangement 100 comprises a chassis bracket 50. The chassis bracket 50 is adapted to be mounted to the chassis 300.

The mounting arrangement 100 comprises a cab bracket 60. The cab bracket 60 is adapted to be mounted to the cab 200.

In addition, the mounting arrangement 100 comprises a mounting unit 10. The mounting unit 10 is adapted to connect the chassis bracket 50 and the cab bracket 60. Thus, the mounting unit 10 may be adapted to be connected to the chassis bracket 50 and to the cab bracket 60. The mounting unit 10 may be connected to the chassis bracket 50 and to the cab bracket 60.

The mounting unit 10 comprises a core member 45. The core member 45 comprises an aperture 11. The aperture 11 is arranged to extend along a mounting axis MA. The mounting axis MA extends at least partially in a vertical direction.

The mounting arrangement 100 further comprises a fastening member 20. The fastening member 20 is adapted to be mounted to the mounting unit 10. The fastening member 20 is adapted to be mounted to the chassis bracket 50. The fastening member 20 is arranged to extend along the mounting axis MA inside the aperture 11.

The mounting arrangement 100 allows for vertical mounting of the cab 200 to the chassis 300 and a vertical interface for said mounting. The interface allows for easier mounting of the cab to the chassis and aligning of the cab to the chassis.

Further, the mounting arrangement according to the above enables additional space in the mounting arrangement for flexible elements and bushing for counteracting vibrations as well as compression and/or rebound travel.

In addition, the vertical interface allows for easier mounting and aligning due to enabling the cab to rest on the vertical interface during said mounting and aligning.

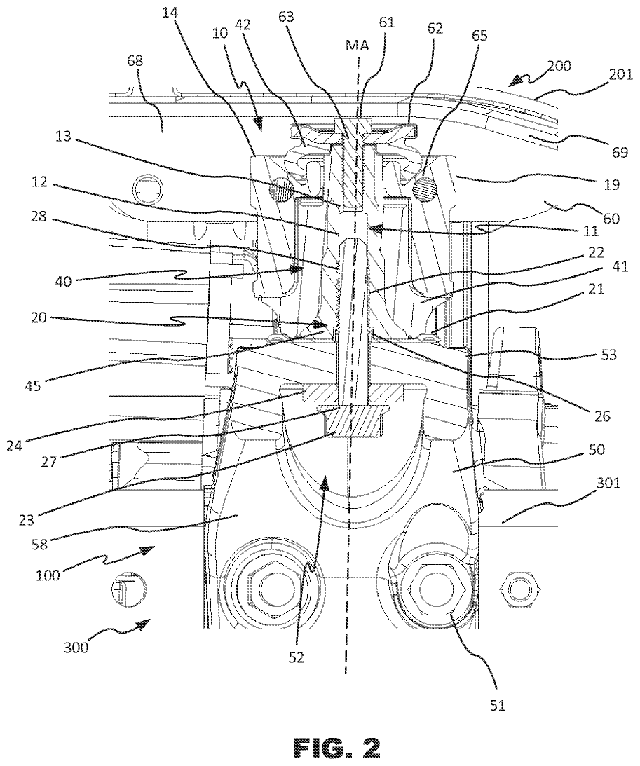

FIG. 2 is a side view of a mounting arrangement of one example. A cross-section of the mounting arrangement is depicted.

In the depicted example, the vehicle may be a heavy vehicle such as a truck, bus or construction vehicle. It may however be envisioned that the vehicle is an automobile.

The mounting arrangement 100 may be a cab mounting isolator. Thus, the mounting arrangement 100 may be adapted to mitigate propagation of vibrations from the chassis to the cab.

The mounting arrangement 100 may be a front mounting arrangement. The mounting arrangement 100 may thus be adapted to connect a front portion of the chassis 300 and cab 200. The mounting arrangement 100 may be adapted to be mounted to a front portion of the chassis 300 and a front portion of the cab 200. A front portion may herein refer to a portion disposed in the front of the vehicle relative the forward travelling direction.

As described with reference to FIG. 1, the fastening member 20 is adapted to be mounted to one of the cab bracket 60 and the chassis bracket 50. Accordingly, the fastening member is mounted to either the cab bracket 60 or the chassis bracket 50.

The fastening member 20 may comprise a first end portion 27. The first end portion 27 may be adapted to be mounted to the cab bracket 60. Alternatively, the first end portion 27 may be adapted to be mounted to the chassis bracket 50. The fastening member 20 may comprise a second end portion 28. The second end portion 28 may be opposite to the first end portion 27. The second end portion 28 may be opposite to said first end portion 27 relative a lengthwise direction of the fastening member 20. The second end portion 28 may be adapted to be arranged inside the aperture 11.

The second end portion 28 may be fully accommodated in the aperture 11 such that it does not protrude outside said aperture 11 and the mounting unit 10.

The second end portion 28 may be arranged such that it does not engage the cab bracket 60 or the chassis bracket 50. In one example, the first end portion 27 may be mounted to the cab bracket 60, whereby the second end portion 28 may be arranged such that it does not engage the chassis bracket 50. In one example, the first end portion 27 may be mounted to the chassis bracket 50, whereby the second end portion 28 may be arranged such that it does not engage the cab bracket 60.

Referencing FIG. 2, the fastening member 20 may be adapted to be mounted to the chassis bracket 50. Hence, the first end portion 27 may be adapted to be mounted to the chassis bracket 50. By means of having the fastening member 20 mounted to chassis bracket 50 instead of the cab bracket 60, the mounting unit 10 may be mounted to the cab 200 before the cab 200 is placed on the chassis bracket 50 allowing for easy mounting and aligning.

Further referencing FIG. 2, the second end portion 28 may be an upper portion of the fastening member 20 and the first end portion 27 may be lower portion of the fastening member 20.

The fastening member 20 may be in the form of any conventional fastening member suitable for the application. In the depicted example, fastening member 20 may have a threaded portion 22. The threaded portion 22 may be adapted to engage a corresponding threaded portion of the aperture 11. The fastening member 20 may be in the form of a screw.

The fastening member 20 may have a have a fastening member head 23. The mounting arrangement 100 may further comprise a washer member 24. The washer member 24 may be arranged between the fastening member head 23 and the chassis bracket 50 or the cab bracket 60.

In order for the cabin to rest on the chassis bracket 50 in a stable and secure manner, the chassis bracket 50 may comprise a mounting flange 53. The mounting flange 53 may be adapted to support the mounting unit 10 such that the mounting unit 10 is supported by the mounting flange 53. Thereby, the mounting unit 10 may be mounted to cab bracket 60 and be arranged on the mounting flange 53, whereby the fastening member 20 may be mounted to the chassis bracket 50 and inserted and mounted to the mounting unit 10 via the aperture of the core member 45.

The mounting flange 53 may comprise an upper support surface. A lower surface of the mounting unit 10 may be supported by the upper support surface. The lower surface of the mounting unit 10 may rest upon the upper support surface.

In one example, the fastening member 20 may be mounted to the mounting flange 53. The mounting flange 53 may comprise a hole adapted to receive the fastening member 20. The hole of the mounting flange 53 may extend along the mounting axis MA.

In the depicted example, the washer member 24 is arranged between the fastening member head 23 and the mounting flange 53. Thus, the fastening member head 23 is clamped between the mounting flange 53 and the fastening member head 23.

The mounting arrangement 100 may comprise a bushing 40. The core member 45 may be mounted to the bushing 40.

Further, the vertical interface allows for use of a bushing enabling more travel with softer rubber while achieving good durability and preventing additional maintenance. In conventional mounting arrangements, a compromise between good driver comfort and good durability of the mounting arrangement usually has to be made.

Advantageously, the bushing 40 may be in a flexible material. The bushing 40 may be in an elastic material.

The flexible material may be an elastomeric material such as rubber.

The core member 45 may be resiliently arranged in the bushing 40.

Further referencing FIG. 2, the core member 45 and the bushing 40 may be coaxially arranged along the mounting axis MA. Further, the aperture 11 of the core member 45 and the bushing 40 may be coaxially arranged along the mounting axis MA.

The core member 45 may be in a rigid material such as metal. Preferably, the core member 45 is in aluminum or steel.

The bushing 40 may be mounted to the core member 45. The bushing 40 may form a sleeve treaded onto the core member 45. Advantageously, the bushing 40 may wrap around the core member 45. The bushing 40 may be substantially annular.

As further depicted in FIG. 2, the mounting unit 10 may comprise a housing 14. The housing 14 may form an outer surface of the mounting unit 10. The housing 14 may be mountable to the chassis bracket 60 and the cab bracket 50.

In the depicted example, the bushing 40 may be mounted to the housing 14. The bushing 40 may be arranged between the housing 14 and the core member 45.

The core member 45 may be arranged inside the housing 14. Accordingly, the housing 14 may be adapted to accommodate the core member 45.

The bushing 40 may be fitted into the housing 14. The bushing 40 may separate the core member 45 from the housing 14. Due to the bushing 40 preferably being in a flexible material, the bushing 40 may be adapted to flexibly retain the core member 45 to the housing 14. The bushing 40 may thus provide damping between the core member 45 and the housing 14. The bushing 40 may allow for relative movement between the core member 45 and the housing 14.

The fastening member 20 may be adapted to be mounted to the mounting unit 10. As aforementioned, the fastening member 20 may be adapted to be mounted to one of the cab bracket 60 and the chassis bracket 50. The housing 20 may be adapted to be mounted to the other of said cab bracket 60 and chassis bracket 50.

In the depicted example, the fastening member may be mounted to the housing 14 and to the chassis bracket 50. Further, the housing 14 may be mounted to the cab bracket 50. The housing 14 may be mounted to the cab bracket 50 by means of one or more housing fastening elements 65. The housing fastening elements 65 may be horizontally arranged. The housing fastening elements 65 may extend through holes in the housing and corresponding holes in the cab bracket 50.

Again referencing FIG. 2, the mounting arrangement 100 may be provided with means for controlling the load exerted on the cab from the chassis and the behavior of the cab in relation to the chassis. Hence, the mounting arrangement may function as a cab mount isolator. Thus, the mounting arrangement 100 may be considered a cab mount isolator.

The mounting arrangement 100 may comprise a cab damping member 42. The cab damping member 42 may be arranged at an end of the mounting unit 10 facing the cab bracket 60. The cab damping member 42 may be arranged between the core member 45 and the cab bracket 60.

The cab damping member 42 allows for control of the rebound travel of the cab 200 relative the chassis 300.

Rebound travel refers to the movement of the cab as suspension between the cab and chassis rebounds after being compressed, such as when the vehicle goes over a bump or a pothole.

When the vehicle encounters a bump, the cab damping member 42 may compress to absorb the shock, and when the cab moves back to its original position, the cab damping member 42 rebounds, or expands back to its original length. This is what is known as rebound travel.

The amount of rebound travel is determined by the design of the cab damping member. A cab damping member that is too soft or has too much rebound travel can lead to instability, while a cab damping member that is too stiff can result in a harsh ride.

Rebound travel is an important factor in determining a vehicle's overall ride quality and handling characteristics, and suspension systems are designed to balance the need for good handling with a comfortable ride.

Thus, the cab damping member 42 may be adapted to control rebound travel of the cab 200 relative the chassis 300. The cab damping member 42 may be adapted to control vertical rebound travel of the cab 200 relative the chassis 300.

The cab damping member 42 may be in a flexible material such as an elastomeric material such as rubber.

The cab damping member 42 may be arranged at an upper portion of the mounting unit 10. The cab damping member 42 may face a lower surface of the cab bracket 60.

The cab damping member 42 may be connected to the housing 14 of the mounting unit 10. The cab damping member 42 may be provided as an annular element crimped onto a collar of the mounting unit 10. The housing 14 may comprise the collar.

In the depicted example, the cab damping member 42 may be provided in the form of a bump-stop. Hence, the cab damping member 42 may be considered a bump-stop.

The mounting arrangement 100 may comprise a chassis damping member 41. The chassis damping member 41 may be arranged at an end of the mounting unit 10 facing the chassis bracket 50. The chassis damping member 41 may be arranged between the core member 45 and the chassis bracket 50.

The chassis damping member 41 allows for control of the compression travel of the cab 200 relative the chassis 300.

Compression travel refers to the movement of the cab as suspension between the cab and chassis when the vehicle is traveling over uneven surfaces such as bumps, potholes, or speed bumps. When a vehicle encounters a bump or uneven terrain, the chassis will move upwards, and the chassis damping member may compress to absorb the shock.

The compression travel may be considered the distance that the chassis damping member travels when it compresses. This distance is important because it determines how well the mounting arrangement can absorb shocks and vibrations from the road surface. A longer compression travel distance can provide a smoother ride and reduce the impact of shocks on the vehicle's body and components.

Compression travel is influenced by the design of the chassis damping member. The chassis damping member may be designed to enable a longer compression travel distance to provide a smoother ride or a shorter travel distance to provide better handling and stability.

Overall, compression travel plays a significant role in determining the ride quality and handling of a vehicle.

Thus, the chassis damping member 41 may be adapted to control compression travel of the cab 200 relative the chassis 300. The chassis damping member 41 may be adapted to control vertical compression of the cab 200 relative the chassis 300.

The chassis damping member 41 may be in a flexible material such as an elastomeric material such as rubber.

The chassis damping member 41 may be arranged at a lower portion of the mounting unit 10. The chassis damping member 41 may face an upper surface of the chassis bracket 50.

The chassis damping member 41 may be connected to the housing 14 of the mounting unit 10. The chassis damping member 41 may also be connected to the core member 45. In one example, the chassis damping member 41 may be mounted to the core member 45.

The chassis damping member 41 may be provided as an annular element. The chassis damping member 41 may be crimped onto the core member 45. A portion of the chassis damping member 41 may protrude out of the housing 14.

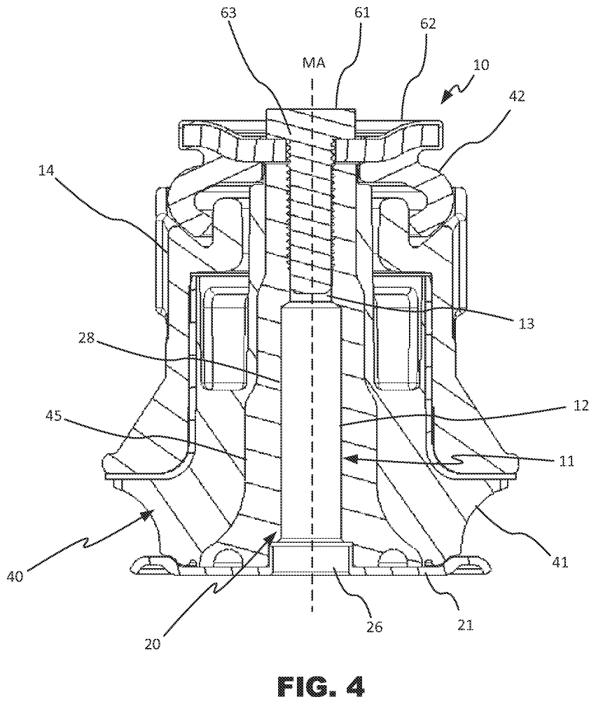

Further referencing FIG. 4, the fastening member 20 may be provided with a fastening member washer 21. The fastening member washer 21 may be an embedded washer. The chassis damping member 41 may be clamped between the fastening member washer 21 and the mounting unit 10. The chassis damping member 41 may be clamped between the fastening member washer 21 and the housing 14.

The fastening member washer 21 may be arranged to be brought into contact with the chassis bracket. Advantageously, the fastening member washer 21 may be arranged to be brought into contact with the mounting flange of the chassis bracket.

In the depicted example, a lower surface of the fastening member washer 21 is in contact with an upper surface of the chassis bracket, e.g. an upper surface of the mounting flange.

The chassis damping member 41 and/or the cab damping member 42 may be formed as a separate element.

The chassis damping member 41 and/or the cab damping member 42 may be formed as an integrated part of the bushing 40.

In the depicted example, the cab damping member 42 may be formed as a separate element while the chassis damping member 41 is provided as an integrated part of the bushing 40. Hence, the chassis damping member 41 may be provided as a portion of the bushing protruding out of the housing 14 towards the chassis bracket 50.

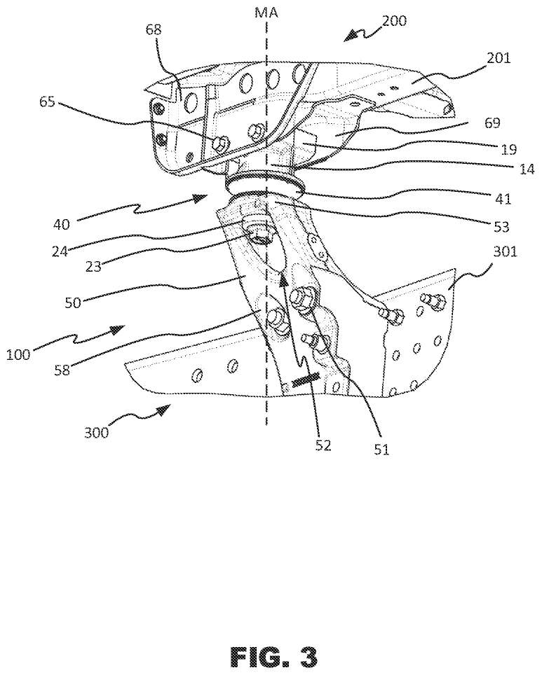

FIG. 3 depicts a mounting arrangement of one example in a perspective view.

The chassis bracket 50 may be adapted to extend from the chassis 300. The chassis bracket 50 may be adapted to extend from the chassis 300 in a direction extending at least partially along the mounting axis MA.

The chassis bracket 50 may comprise a chassis bracket arm member 58. The chassis bracket arm member 58 may be arranged to protrude from the chassis at least partially along the mounting axis MA and towards the cab bracket 60.

The chassis bracket 50 may be adapted to extend at least partially in a vertical direction. The chassis bracket arm member 58 may be adapted to extend at least partially in a vertical direction.

The chassis bracket 50 may be mounted to the chassis 300, e.g. the chassis frame 301 via one or more chassis bracket fasteners 51. In one example, the one or more chassis bracket fasteners 51 may be in the form of bolts. The one or more chassis bracket fasteners 51 may be horizontally arranged. The one or more chassis bracket fasteners 51 may be arranged in corresponding holes in the chassis bracket 50 and the chassis 300.

In the depicted example, the chassis bracket arm member 58 may be provided with one or more holes adapted to receive the one or more chassis bracket fasteners 51 for mounting of the chassis bracket 50 to the chassis 300, e.g. the chassis frame 301.

The cab bracket 60 may be adapted to extend from the cab 200. The cab bracket 60 may be adapted to extend from the cab 200 in a direction extending at least partially along the mounting axis MA.

The cab bracket 60 may comprise a cab bracket flange 68. The cab bracket flange 68 may be arranged to protrude from the cab 200 at least partially along the mounting axis MA and towards the chassis bracket 50.

The cab bracket 60 may be adapted to extend at least partially in a vertical direction.

The cab bracket 60 may be provided with one or more holes for receiving the one or more housing fastening elements 65 for mounting the mounting unit 10 to the cab bracket 60. In one example, the cab bracket flange 68 may be provided with the one or more holes for receiving the one or more housing fastening elements 65 for mounting the mounting unit 10 to the cab bracket 60.

The cab bracket 60 may comprise a guiding portion 69. The guiding portion 69 may be adapted to provide a guide for movement of the mounting unit 10. The guiding portion 69 may be adapted to provide a guide for movement of the mounting unit 10 in a direction extending substantially orthogonally to the mounting axis MA. The guiding portion 69 may extend in a horizontal direction.

The guiding portion 69 may be adapted to receive a portion of the mounting unit 10. The mounting unit 10 may be movable received in the guiding portion 69. The guiding portion 69 may thus be movably mounted to the guiding portion 69. The mounting unit 10 may be movable along the guiding portion 69. The mounting unit 10 may be movable along the guiding portion 69 to a mounting position wherein the mounting unit 10 is aligned with the chassis bracket.

The guiding portion 69 may be adapted to receive an upper portion of the mounting unit 10. The guiding portion 69 may be adapted to receive the housing 14 of the mounting unit 10. The guiding portion 69 may be adapted to receive an upper portion of the housing 14.

The guiding portion 69 may form a guiding track. The guiding track may extend substantially orthogonally to the mounting axis MA. The guiding track may comprise a profile element. In the depicted example, the guiding track comprises a U-profile.

In the depicted example, the guiding portion 69 is arranged to extend along the length of the vehicle. It may however be envisioned that the guiding portion may extend along the width of the vehicle.

In one example, the guiding portion 69 may be formed as a part of the cab bracket flange 68. In one example, the guiding portion 69 may be mounted to the cab bracket flange 68.

FIG. 4 depicts a cross-section of a mounting unit of a mounting arrangement of one example.

Referencing FIG. 4, the mounting arrangement 100 may comprise a mounting unit fastening element 63. The mounting unit fastening element 63 may be adapted to be mounted to the mounting unit 10. The mounting unit fastening element 63 may be provided with a washer element 62. The cab damping member 42 may be clamped between the washer element 62 and the housing 14.

The washer element 62 may be arranged to come into contact with the cab bracket.

The mounting unit fastening element 63 may be arranged to extend along the mounting axis MA. The mounting unit fastening element 63 may be connected to the core member 45.

The mounting unit fastening element 63 may be mounted to the aperture 11. Thus, both the fastening member 20 and the mounting unit fastening element 63 may be mounted to the aperture 11.

The aperture 11 may comprise a first aperture section 12 and a second aperture section 13. The second aperture section 13 may axially displaced relative the first aperture section 12 along the mounting axis MA. The first aperture section 12 may be adapted to receive the fastening member 20. The second aperture section 13 may be adapted to receive the mounting unit fastening element 63.

In the depicted example, the fastening member 20 is mounted to the chassis bracket. The first aperture section 12 may thus be considered a lower portion of the aperture 11. Correspondingly, the second aperture section 13 may be considered an upper portion of the aperture 11.

The aperture 11 may be adapted to secure the position of the fastening member 20 and the mounting unit fastening element 63. Thereby, the potential risk for the fastening member 20 and the mounting unit fastening element 63 coming into contact is mitigated.

The diameter of the first aperture section 12 may have a different diameter than the second aperture section 13. Preferably, the first aperture section 12 may have a larger diameter than the section aperture section 13. Thereby, a seat for the fastening member 20 is provided by the walls of the second aperture section 13. The formed seat secures the position of the fastening member 20.

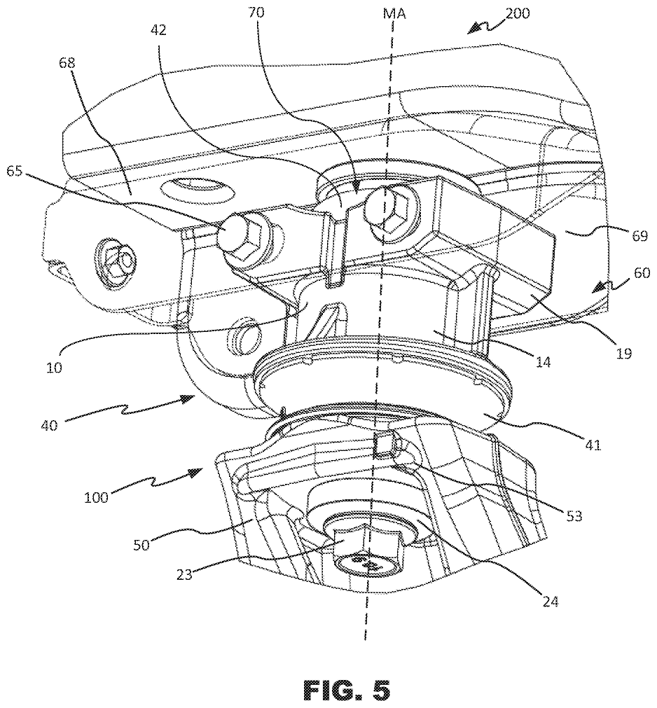

FIG. 5 shows a more detailed view of a mounting arrangement 100 according to one example. Unless otherwise is stated, the mounting arrangement 100 may comprise any one of the features described with reference to FIG. 1-4.

FIG. 5 depicts a portion of the mounting unit 10 and the cab damping member 42. Hence, FIG. 5 may depict an upper portion of the mounting arrangement 100. As previously described, the cab damping member 42 may be arranged at an end of the mounting unit 10 facing the cab bracket 60.

The cab damping member 42 may be arranged in a depression 70. The depression 70 may be arranged at the end of the mounting unit 10 facing the cab bracket 60. The depression 70 may be configured such that the cab damping member 42 engages with the depression 70 upon rebound travel causing compression of said cab damping member 42 to provide isolation of the rebound travel. Thus, the depression may enable a smoother and more comfortable ride.

The depression 70 may have a depth extending substantially along the mounting axis MA. The mounting unit 10 may comprise the depression 70. In the depicted example, the housing 14 of the mounting unit 10 comprises the depression 70. In the depicted example, the housing 14 comprises a mounting portion 19 forming the end of the mounting unit 10 facing the cab bracket 60. The mounting portion 19 may be provided as flanged portion protruding substantially perpendicular to the mounting axis MA. An outer surface extending substantially perpendicular to the mounting axis MA, e.g. an upper surface, of the mounting portion 19 may be provided with the depression 70.

As depicted in FIG. 5, the housing fastening elements 65 may extend through holes in the housing here provided as holes in the mounting portion 19.

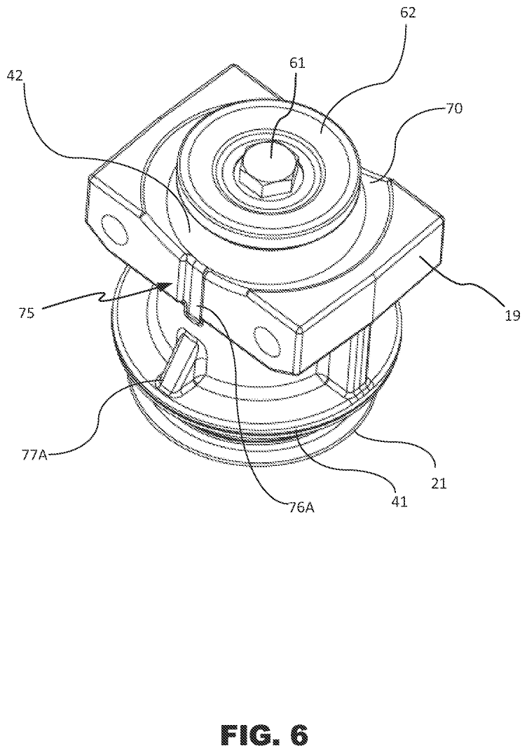

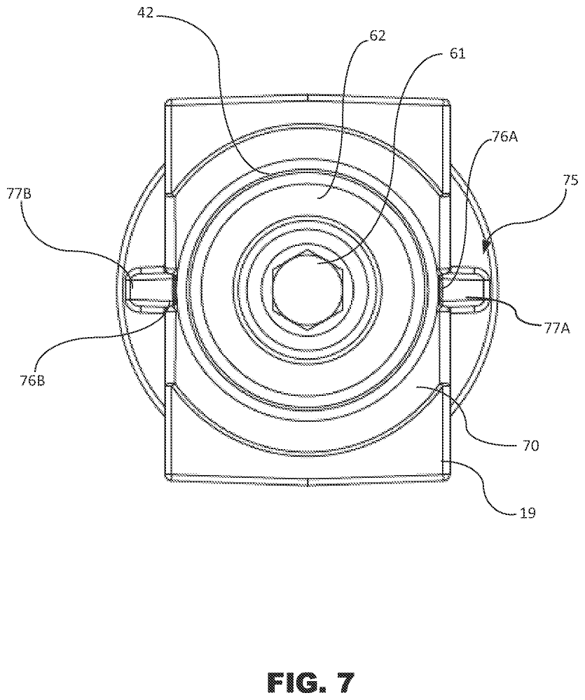

FIGS. 6 and 7 depicts the depression 70 and cab damping member 42 of FIG. 5 in further detail. Referencing said figures, the mounting unit 10 may comprise a draining arrangement 75 to prevent liquid, e.g. water, accumulating in the depression and lower the performance and increase the wear of the cab damping member 42.

The mounting unit 10 may comprise the draining arrangement 75. The draining arrangement 75 may be in fluid communication with the depression 70 to drain liquid accumulated in the depression 70.

The draining arrangement 75 may comprise one or more drain channel 76. The drain channel 76 may extend from the depression 70 in a direction extending at least partially parallel to the mounting axis MA. In the depicted example, the drain channel 76 extends downwards from the depression 70. Accordingly, the drain channel 76 may be arranged to guide liquid out of the depression 70 by means of gravity.

In the depicted example, the drain channel 76 is formed by an elongated recess provided in the housing 14 of the mounting unit 10 and preferably the mounting portion 19 of the housing 14. In the depicted example, an inlet portion of the drain channel 76 is formed as a slot in the outer circumference of the depression 70. The slot may be arranged at a distance from the cab damping member 42 in a direction extending substantially orthogonally to the mounting axis MA. It may however also be envisioned that an inlet portion of the drain channel 76 may be formed by a hole provided in the surface of the depression 70.

Further referencing FIG. 6-7, the draining arrangement 75 may comprise more than one drain channel 76. In the depicted example, two drain channels 76A, 76B are provided. A first drain channel 76A is provided on a first side of the cab damping member 42 relative to the mounting axis MA and a second drain channel 76B is provided on a second side of the cab damping member 42 relative to the mounting axis MA. The second side may be opposite to the first.

In one example, a downstream portion of the one or more drain channel 76 may configured to lead the liquid away from the mounting unit, it may however be envisioned that outlet guides may be utilized for this purpose. Thus, the draining arrangement 75 may comprise at least one outlet guide 77 for guiding liquid, such as water, away from the mounting unit 10. Accordingly, the draining arrangement 75 may comprise at least one outlet guide 77. Each outlet guide 77 may be arranged downstream of the drain channel 76 relative to the depression 70. The at least one outlet guide 77 may be oriented at an outward angle relative to the mounting axis MA such that liquid passing through the drain channel 76 is guided outwards and away from the mounting unit 10. In the depicted example, the outlet guide(s) 77 are arranged at a downward angle relative to the mounting axis MA.

In the depicted example, the outlet guide 77 is formed as a separate element arranged downstream from the drain channel 76 such that liquid having passed through the drain channel 76 falls towards the outlet guide 77, whereby the outlet guide 77 guides the liquid away from the mounting unit 10. As depicted in FIG. 6-7, the outlet guide 77 is formed as a protrusion with an elongated recess extending at an angle relative to mounting axis MA. The protrusion may be provided on the housing 14. It may however be envisioned that the outlet guide 77 is directly connected to the drain channel 76 and forms an angled extension of said drain channel 76.

In the depicted example, a first outlet guide 77A is arranged downstream of the first drain channel 76A and a second outlet guide 77B is arranged downstream of the second drain channel 76B.

A mounting arrangement according to any of the following examples may be provided.

Example 1: A mounting arrangement 100 for mounting a cab 200 to a chassis 300 of a vehicle, the mounting arrangement 100 comprising:
a chassis bracket 50 adapted to be mounted to the chassis 300,
a cab bracket 60 adapted to be mounted to the cab 200, and
a mounting unit 10 adapted to connect the chassis bracket 50 and the cab bracket 60,

wherein the mounting unit 10 comprises a core member 45, the core member 45 comprising an aperture 11 being arranged to extend along a mounting axis MA extending at least partially in a vertical direction,

whereby the mounting arrangement 100 further comprises a fastening member 20 adapted to be mounted to the mounting unit 10 and one of the cab bracket 60 and the chassis bracket 50, the fastening member 20 being arranged to extend along the mounting axis MA inside the aperture 11.

Example 2: The mounting arrangement 100 of example 1, wherein the fastening member 20 comprises a first end portion 27 adapted to be mounted to the cab bracket 60 or the chassis bracket 50 and a second end portion 28 opposite to said first end portion 27 and adapted to be arranged inside the aperture 11.

Example 3: The mounting arrangement 100 of any of examples 1-2, wherein the fastening member 20 is adapted to be mounted to the chassis bracket 50.

Example 4: The mounting arrangement 100 of any of examples 1-3, wherein the chassis bracket 50 comprises a mounting flange 53 adapted to support the mounting unit 10 such that the mounting unit 10 is supported by said mounting flange 53.

Example 5: The mounting arrangement 100 of any of examples 1-4, wherein the mounting unit 10 comprises a bushing 40 and the core member 45 is mounted to the bushing 40.

Example 6: The mounting arrangement 100 of example 5, wherein the bushing 40 is in a flexible material such as an elastomeric material.

Example 7: The mounting arrangement 100 of example 6, wherein the core member 45 is resiliently arranged in the bushing 40.

Example 8: The mounting arrangement 100 of any of examples 5-7, wherein the core member 45 and the bushing 40 are coaxially arranged along the mounting axis MA.

Example 9: The mounting arrangement 100 of any of example 5-8, wherein the mounting unit 10 further comprises a housing 14, whereby the bushing 40 is mounted to the housing 14 and the bushing 40 is arranged between the housing 14 and the core member 45.

Example 10: The mounting arrangement 100 of example 9, wherein the fastening member 20 is adapted to be mounted to the mounting unit 10 and to one of the cab bracket 60 and the chassis bracket 50 and wherein the housing 14 is adapted to be mounted to the other of said cab bracket 60 and chassis bracket 50.

Example 11: The mounting arrangement 100 of any of examples 1-10, further comprising: a cab damping member 42 arranged at an end of the mounting unit 10 facing the cab bracket 60, whereby the cap damping member 42 is arranged between the core member 45 and the cab bracket 60.

Example 12: The mounting arrangement 100 of any of examples 1-11, further comprising: a chassis damping member 41 arranged at an end of the mounting unit 10 facing the chassis bracket 50, whereby the chassis damping member 41 is arranged between the core member 45 and the chassis bracket 50.

Example 13: The mounting arrangement 100 of any of examples 11-12, wherein the chassis damping member 41 and/or the cab damping member 42 is formed as an integrated part of the bushing 40.

Example 14: The mounting arrangement 100 of any of examples 11-13, wherein the chassis damping member 41 and/or the cab damping member 42 are formed as a separate element.

Example 15: The mounting arrangement 100 of any of examples 1-14, wherein cab bracket 60 comprises a guiding portion 69 adapted to provide a guide for movement of the mounting unit 10 in a direction extending substantially orthogonally to the mounting axis MA.

Example 16: The mounting arrangement 100 of any of examples 11-15, further comprising: a mounting unit fastening element 63 adapted to be mounted to the mounting unit 10, whereby the mounting unit fastening element 63 is provided with a washer element 62 and the cab damping member 42 is clamped between the washer element 62 and the housing 14.

Example 17: The mounting arrangement 100 of example 16, wherein the aperture 11 comprises a first aperture section 12 and a second aperture section 13, wherein the second aperture section 13 is axially displaced relative the first aperture section 12 along the mounting axis MA and wherein the first aperture section 12 is adapted to receive the fastening member 20 and the second aperture section 13 adapted to receive the mounting unit fastening element 63.

Example 18: The mounting arrangement 100 of example 17, wherein the first aperture section 12 has a larger diameter than the second aperture section 13.

Example 19: The mounting arrangement 100 of any of examples 1-18, wherein the chassis bracket 50 is adapted to extend from the chassis 300 in a direction extending at least partially along the mounting axis MA and/or the cab bracket 60 is adapted to extend from the cab 200 in a direction extending at least partially along the mounting axis MA.

Example 20: The mounting arrangement 100 of any of examples 11-19, wherein the cab damping member 42 is arranged in a depression 70 at the end of the mounting unit 10 facing the cab bracket 60.

Example 21: The mounting arrangement 100 of example 20, wherein the mounting unit 10 comprises a draining arrangement 75 in fluid communication with the depression 70 to drain liquid accumulated in the depression 70.

Example 22: The mounting arrangement 100 of example 21, wherein the draining arrangement 75 comprises one or more drain channel 76 extending from the depression 70 in a direction extending at least partially parallel to the mounting axis MA.

Example 23: The mounting arrangement 100 of example 22, wherein the draining arrangement 75 comprises at least one outlet guide 77, each outlet guide 77 being arranged downstream of a drain channel 76 relative to the depression 70, wherein the at least one outlet guide 77 is oriented at an outward angle relative to the mounting axis MA such that liquid passing through the drain channel 76 is guided outwards and away from the mounting unit 10.

Example 20: A vehicle comprising a cab 200, a chassis 300 and a mounting arrangement 10 of any of examples 1-19.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A mounting arrangement for mounting a cab to a chassis of a vehicle, the mounting arrangement comprising:
a chassis bracket adapted to be mounted to the chassis;
a cab bracket adapted to be mounted to the cab; and
a mounting unit adapted to connect the chassis bracket and the cab bracket;
wherein the mounting unit comprises a core member, the core member comprising an aperture being arranged to extend along a mounting axis extending at least partially in a vertical direction; and
whereby the mounting arrangement further comprises a fastening member adapted to be mounted to the mounting unit and one of the cab bracket and the chassis bracket, the fastening member being arranged to extend along the mounting axis inside the aperture.

2. The mounting arrangement of claim 1, wherein the fastening member comprises a first end portion adapted to be mounted to the cab bracket or the chassis bracket and a second end portion opposite to said first end portion and adapted to be arranged inside the aperture.

3. The mounting arrangement of claim 1, wherein the fastening member is adapted to be mounted to the chassis bracket.

4. The mounting arrangement of claim 1, wherein the chassis bracket comprises a mounting flange adapted to support the mounting unit such that the mounting unit is supported by said mounting flange.

5. The mounting arrangement of claim 1, wherein the mounting unit comprises a bushing and the core member is mounted to the bushing.

6. The mounting arrangement of claim 5, wherein the bushing is in a flexible material such as an elastomeric material.

7. The mounting arrangement of claim 6, wherein the core member is resiliently arranged in the bushing.

8. The mounting arrangement of claim 6, wherein the core member and the bushing are coaxially arranged along the mounting axis.

9. The mounting arrangement of claim 5, wherein the mounting unit further comprises a housing, whereby the bushing is mounted to the housing and the bushing is arranged between the housing and the core member.

10. The mounting arrangement of claim 9, wherein the fastening member is adapted to be mounted to the mounting unit and to one of the cab bracket and the chassis bracket and wherein the housing is adapted to be mounted to the other of said cab bracket and chassis bracket.

11. The mounting arrangement of claim 1, further comprising:
a cab damping member arranged at an end of the mounting unit facing the cab bracket, whereby the cap damping member is arranged between the core member and the cab bracket.

12. The mounting arrangement of claim 1, further comprising:
a chassis damping member arranged at an end of the mounting unit facing the chassis bracket, whereby the chassis damping member is arranged between the core member and the chassis bracket.

13. The mounting arrangement of claim 11, wherein the chassis damping member and/or the cab damping member is formed as an integrated part of the bushing.

14. The mounting arrangement of claim 11, wherein the chassis damping member and/or the cab damping member are formed as a separate element.

15. The mounting arrangement of claim 1, wherein cab bracket comprises a guiding portion adapted to provide a guide for movement of the mounting unit in a direction extending substantially orthogonally to the mounting axis.

16. The mounting arrangement of claim 11, further comprising:
a mounting unit fastening element adapted to be mounted to the mounting unit, whereby the mounting unit fastening element is provided with a washer element and the cab damping member is clamped between the washer element and the housing.

17. The mounting arrangement of claim 16, wherein the aperture comprises a first aperture section and a second aperture section, wherein the second aperture section is axially displaced relative to the first aperture section along the mounting axis and wherein the first aperture section is adapted to receive the fastening member and the second aperture section adapted to receive the mounting unit fastening element.

18. The mounting arrangement of claim 17, wherein the first aperture section has a larger diameter than the second aperture section.

19. The mounting arrangement of claim 1, wherein the chassis bracket is adapted to extend from the chassis in a direction extending at least partially along the mounting axis and/or the cab bracket is adapted to extend from the cab in a direction extending at least partially along the mounting axis.

20. A vehicle comprising a cab, a chassis, and the mounting arrangement of claim 1.
